(19) United States
(12) Patent Application Publication
(10) Pub. No.: US 2005/0252535 A1
(43) Pub. Date: Nov. 17, 2005

(54) Substrate cleaning apparatus and method

(76) Inventors: Yukiko Nishioka, Tokyo (DE); Koji Ato, Tokyo (JP); Ryosuke Yonekura, Ebina-shi (JP); Yoshikazu Ariga, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/536,961

(22) PCT Filed: May 26, 2004
(86) PCT No.: PCT/JP04/07560

§ 371 Date: May 31, 2005

(30) Foreign Application Priority Data
May 30, 2003 (JP) 2003-154642

(51) Int. Cl. B08B 7/00

(52) U.S. Cl. 134/33; 134/104.2; 134/149; 134/157

(57) ABSTRACT

A substrate cleaning apparatus is used for cleaning and drying a substrate such as a semiconductor wafer used in a semiconductor fabricating process or the like. The substrate cleaning apparatus includes a substrate holding mechanism (10) configured to hold the substrate (W), and a rotating mechanism (20) configured to rotate the substrate holding mechanism (10). At least one of components of the substrate cleaning apparatus has a surface structure to which droplets are hardly attached.

### TECHNICAL FIELD

The present invention relates to a substrate cleaning apparatus and method for cleaning a substrate, and more particularly to a substrate cleaning apparatus and method for cleaning a substrate such as a semiconductor wafer used in a semiconductor fabricating process or the like.

### BACKGROUND ART

In a semiconductor fabricating process, a semiconductor wafer is processed in various processing steps, and then the processed semiconductor wafer is cleaned by supplying a cleaning liquid to a surface of the semiconductor wafer. For example, in a polishing step in which a semiconductor wafer is polished, a surface of the semiconductor wafer which has been polished is cleaned by supplying a cleaning liquid to remove a polishing liquid such as a slurry and ground-off material attached to the semiconductor wafer from the semiconductor wafer. After such cleaning, the semiconductor wafer is rotated at a high speed to remove any remaining liquid from the surface of the semiconductor wafer under a centrifugal force, and is thus dried.

There has heretofore been a cleaning apparatus shown in FIG. 1 to perform the above cleaning process. As shown in FIG. 1, a substrate cleaning apparatus 100 comprises a substrate holding mechanism 102 disposed in a cleaning chamber 101 for holding a peripheral portion of a substrate W, and a rotating mechanism 103 disposed in the cleaning chamber 101 for rotating the substrate holding mechanism 102. In the cleaning chamber 101, there are provided upper cleaning nozzles 104 for cleaning an upper surface of the substrate W, lower cleaning nozzles 105 for cleaning a lower surface of the substrate W, a cup 106, cleaning nozzles 107 disposed in the cup 106, and cleaning nozzles 108 for cleaning the interior of the cleaning chamber 101.

FIGS. 2 and 3 show the substrate holding mechanism and an upper part of the rotating mechanism, and FIG. 2 is a plan view of the substrate holding mechanism and FIG. 3 is a cross-sectional view of the substrate holding mechanism and the upper part of the rotating mechanism. As shown in FIGS. 2 and 3, the substrate holding mechanism 102 has four arms 109 extending radially outwardly from a central base portion, and substrate guide members 110 having inclined surfaces at their inner sides and attached to respective forward ends of the arms. The arms 109 and the central base portion are integrally formed. Holding members comprising a holding claw (not shown) or the like which are rotatable about shafts 111 are mounted on the substrate guide members 110. The holding members are coupled to respective bar members 115 which are normally urged downwardly by respective coil springs 112. Thus, the holding members are normally pressed against the peripheral portion of the substrate W to hold the substrate W. By lifting the bar members 115 by pushers 113, the holding members are rotated or inclined outwardly to release the substrate W.

A cup-like member 116 having an opening downwardly is fixed to a lower surface of the central base portion from which the four arms 109 are radially extended. The rotating mechanism 103 has a rotating shaft 117 whose upper end portion is located centrally in the cup-like member 116. The central base portion from which the four arms 109 are radially extended is fixed to the upper end of the rotating shaft 117. The rotating shaft 117 is disposed centrally in a support cylinder 118, and is rotatably supported through bearings 119 by the support cylinder 118. Further, a cylindrical member 120 is provided so as to enclose the support cylinder 118, and a step-like cylindrical flange member 121 is attached to the upper portion of the cylindrical member 120.

The flange member 121 has a larger-diameter portion 121a, an intermediate-diameter portion 121b, and a smaller-diameter portion 121c which are arranged in the order of diameter from the bottom. A projecting portion 121d is formed on the upper circumferential portion of the smaller-diameter portion 121c, and flat surfaces 121e and 121f are formed on the upper parts of the intermediate-diameter portion 121b and the larger-diameter portion 121a, respectively. The lower cleaning nozzles 105 are attached to the flat surface 121f of the larger-diameter portion 121a through a bracket 122. Further, the cup-like member 116 and the smaller-diameter portion 121c of the flange member 121 constitute a labyrinth. Reference numeral 123 represents a bellows.

In order to load the substrate W onto the substrate holding mechanism 102, the holding members comprising a holding claw or the like are rotated outwardly by pushing the bar members 115 upwardly with the pushers 113 (the holding members become in open state), and then the substrate W is placed on substrate placing portions 114 of the substrate guide members 110. Thereafter, the pushers 113 are lowered to rotate the holding members inwardly, thereby holding the outer peripheral portion of the substrate W by the four holding members at four points of the substrate W. Then, the substrate holding mechanism 102 is rotated by the rotating mechanism 103, and the substrate W held by the substrate holding mechanism 102 is thus rotated.

In the substrate cleaning apparatus having the above structure, the substrate W to be cleaned is loaded onto the substrate holding mechanism 102, and the substrate holding mechanism 102 holding the substrate W is rotated at a predetermined rotational speed by rotating the rotating shaft 117 of the rotating mechanism 103. A cleaning liquid such as a chemical liquid or pure water (deionized water) is supplied to the upper surface of the substrate W from the upper cleaning nozzles 104 to clean the upper surface of the substrate W. Further, a cleaning liquid may be supplied from the cleaning nozzles 107 and the cleaning nozzles 108 to clean the interior of the cup 106 and the interior of the cleaning chamber 101, respectively.

In the substrate cleaning apparatus 100 having the above structure, the arms 109 and the cup-like member 116 have respective upper surfaces which are formed into substantially flat surfaces, and the intermediate-diameter portion 121b and the larger-diameter portion 121a of the flange member 121 have respective upper surfaces which are formed into flat surfaces 121e and 121f. Therefore, it is difficult for a cleaning liquid flowing onto these flat surfaces and adhering to or remaining on these flat surfaces to flow down, and hence a drying step of the substrate is carried out in such a state that droplets of the cleaning liquid adhere or attach to these flat surfaces. When the substrate holding mechanism 102 holding the substrate W is rotated at a high speed in the drying step in such a state that the droplets adhere to the flat surfaces, air streams are produced as shown by arrows A and B of FIG. 4 in the cleaning chamber 101 of the substrate cleaning apparatus 100. Specifically, as shown by the arrows B, the air streams descend in a central portion of the cleaning chamber 101 and ascend in the vicinity of the inner wall surface of the cleaning chamber 101. Therefore, the droplets adhering or attaching to the surfaces of the components of the substrate holding mechanism 102 and the rotating mechanism 103 are scattered around by being carried by the air streams, and are attached to the surface of the substrate W to cause the substrate W to be contaminated again. The droplets include a polishing liquid such as slurry, ground-off material removed from the substrate, by-products of chemical cleaning, and other contaminants. Particularly, when the substrate W is cleaned using a cleaning liquid comprising pure water (deionized water) to which a chemical or chemicals are added, recontamination of the substrate tends to occur.

Particularly, in a high-speed spin-dry process, as shown by arrows A of FIG. 4, air streams which ascend from the lower part of the cleaning chamber 101 and reach the lower surface (reverse surface) of the substrate W are produced, and thus the lower surface of the substrate W which has been cleaned is contaminated by the droplets which are carried by the air streams.

In order to prevent recontamination of the substrate W by the droplets carried by the above air streams, there has heretofore been provided a drying chamber for performing only a drying operation of the substrate W separately from a cleaning chamber as a distinct unit. However, this measure leads to a large-sized apparatus, an enlargement of an installation area of the apparatus, a complicated control system and a complicated substrate transfer system, and a decrease in conveyance throughput (lowering of a yield rate)

### DISCLOSURE OF INVENTION

The present invention has been made in view of the above problems. It is therefore an object of the present invention to provide a substrate cleaning apparatus and method which can solve the above problems and prevent recontamination of a substrate which has been cleaned in a drying process.

In order to achieve the above object, according to a first aspect of the present invention, there is provided a substrate cleaning apparatus for cleaning a substrate by supplying a cleaning liquid and then drying a cleaned substrate, comprising: a substrate holding mechanism configured to hold the substrate; and a rotating mechanism configured to rotate the substrate holding mechanism; wherein at least one of components of the substrate cleaning apparatus has a surface structure to which droplets are hardly attached.

According to the present invention, since parts of components in the apparatus to which a cleaning liquid tends to be attached have a surface configuration to which droplets are hard to be attached, the droplets containing a polishing liquid such as slurry, ground-off material removed from the substrate by polishing, and contaminants such as by-products of chemical cleaning are hardly attached to such parts. Therefore, the droplets are not carried by air streams in the drying process, and the substrate can be cleaned without being contaminated again.

According to a preferred aspect of the present invention, the surface structure may comprise an inclined surface or a curved surface which enables droplets to flow down.

With the above arrangement, since surfaces of parts (or components) to which a cleaning liquid tends to be attached comprise inclined surfaces or curved surfaces, droplets attached to such parts flow down promptly. Therefore, the droplets are not carried by air streams in the drying process, and the substrate can be cleaned without being contaminated again.

According to a preferred aspect of the present invention, the surface structure may comprise a liquid repellent material or a coating of a liquid repellent material.

With the above arrangement, since surfaces of parts (or components) to which a cleaning liquid tends to be attached are composed of a liquid repellent material or are coated with a liquid repellent material, droplets are hardly attached to such parts. Therefore, the droplets are not carried by air streams in the drying process, and the substrate can be cleaned without being contaminated again.

According to a preferred aspect of the present invention, the substrate holding mechanism may hold an outer peripheral portion of the substrate.

According to a preferred aspect of the present invention, the rotating mechanism may rotate the substrate holding mechanism at a variable rotational speed.

In order to achieve the above object, according to a second aspect of the present invention, there is provided a substrate cleaning method for cleaning a substrate by supplying a cleaning liquid and then drying a cleaned substrate, comprising: holding the substrate by a substrate holding mechanism; and rotating the substrate held by the substrate holding mechanism by a rotating mechanism to remove droplets from the substrate and dry the substrate; wherein a rotational speed of the substrate is changed stepwise in rotating the substrate.

According to the present invention, the rotational speed of the substrate is varied stepwise in the spin-drying process after cleaning of the substrate. For example, the substrate is rotated first at a low speed so that intense air streams are not produced, thereby removing the droplets from the substrate holding mechanism and the like, and then the substrate is rotated at a high speed to dry the substrate. Thus, even if the intense air streams are produced due to the high-speed rotation, because the droplets have been removed from the substrate holding mechanism and the like, there exist no droplets which are carried by the air streams, and the cleaned substrate can be prevented from being contaminated again.

According to a preferred aspect of the present invention, the rotational speed of the substrate may comprise a low rotational speed of the substrate for removing droplets from components of the substrate holding mechanism and a high rotational speed of the substrate for spin-drying the substrate.

With the above arrangement, the rotational speed of the substrate is changed stepwise from a low-rotational speed removing step for removing droplets to a high-rotational speed drying step for drying the substrate. When the substrate is rotated at a high speed in the drying step, even if intense air streams are produced, because the droplets have been removed from the substrate holding mechanism and the like, there exist no droplets which are carried by the air streams, and the cleaned substrate can be prevented from being contaminated again. Further, the substrate can be cleaned and dried within the same unit which is not separated into a cleaning chamber and a drying chamber without recontamination of the substrate.

According to a preferred aspect of the present invention, at least one of the substrate holding mechanism and the rotating mechanism may include at least one component having a surface structure to which droplets are hardly attached.

### BRIEF DESCRIPTION OF DRAWINGS

FIG. 1 is a cross-sectional view of a conventional substrate cleaning apparatus;

FIG. 2 is a plan view of a substrate holding mechanism of the conventional substrate cleaning apparatus shown in FIG. 1;

FIG. 3 is a cross-sectional view of the substrate holding mechanism and an upper part of a rotating mechanism of the conventional substrate cleaning apparatus;

FIG. 4 is a schematic view showing the state in which air streams are produced in a substrate drying process conducted in the conventional substrate cleaning apparatus;

FIG. 5 is a plan view of a substrate holding mechanism of a substrate cleaning apparatus according to a first embodiment of the present invention;

FIG. 6 is a cross-sectional view taken along line VI-VI of FIG. 5;

FIG. 7 is across-sectional view taken along line VII-VII of FIG. 5;

FIG. 8 is a plan view of a substrate holding mechanism of a substrate cleaning apparatus according to a second embodiment of the present invention;

FIG. 9 is a cross-sectional view taken along line IX-IX of FIG. 8;

FIG. 10 is a cross-sectional view taken along line X-X of FIG. 8;

FIG. 11 is a cross-sectional view of a substrate holding mechanism and an upper part of a rotating mechanism of a substrate cleaning apparatus according to an embodiment of the present invention;

FIG. 12 is a cross-sectional view of a substrate holding mechanism of a substrate cleaning apparatus according to another embodiment of the present invention; and

FIG. 13 is a table showing a comparison between a conventional cleaning step and an inventive cleaning step.

### BEST MODE FOR CARRYING OUT THE INVENTION

Next, a substrate cleaning apparatus according to embodiments of the present invention will be described with reference to the drawings.

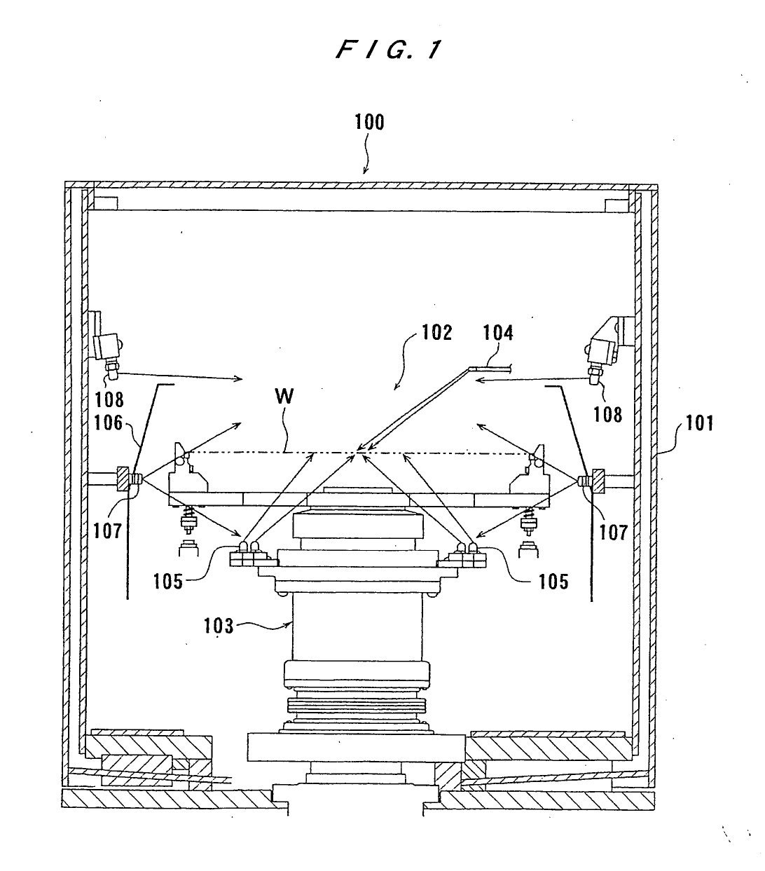

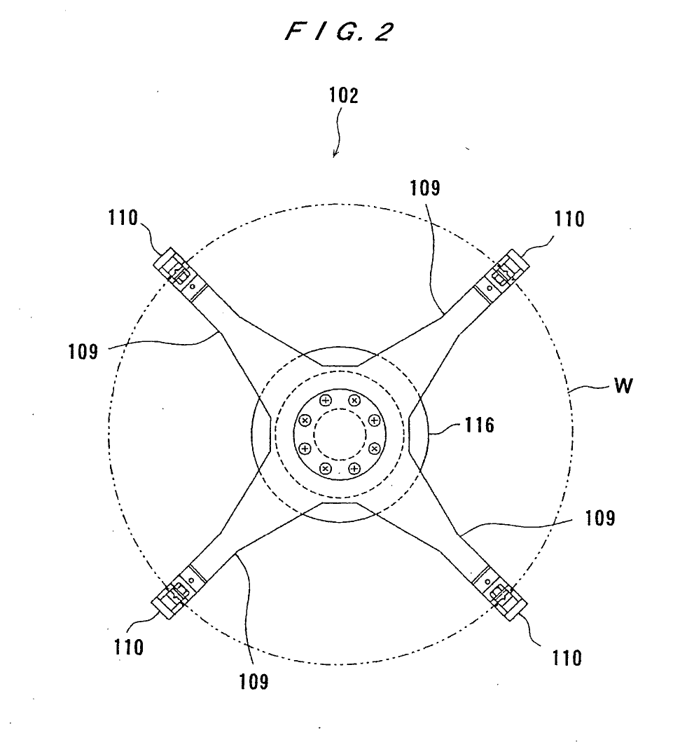

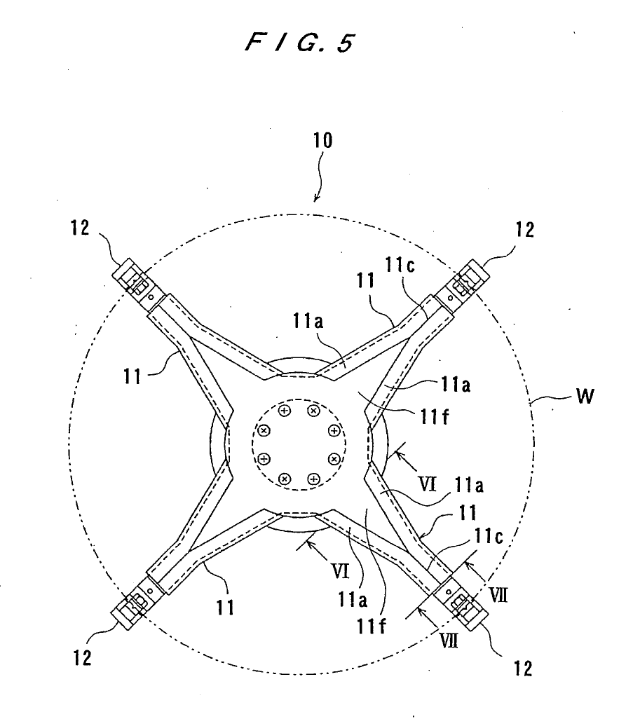

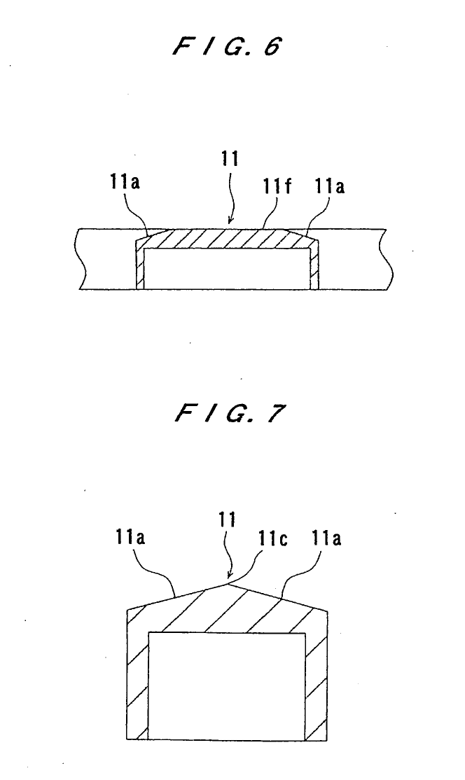

FIGS. 5 through 7 show a substrate cleaning apparatus according to a first embodiment of the present invention. FIG. 5 is a plan view of a substrate holding mechanism of a substrate cleaning apparatus, FIG. 6 is a cross-sectional view taken along line VI-VI of FIG. 5, and FIG. 7 is a cross-sectional view taken along line VII-VII of FIG. 5. As shown in FIG. 5, a substrate holding mechanism 10 of the substrate cleaning apparatus according to the present invention comprises four arms 11 extending radially outwardly from a central base portion, and substrate guide members 12 having inclined surfaces at their inner sides and attached to respective forward ends of the arms in the same manner as the conventional substrate cleaning apparatus shown in FIGS. 1 and 2. Further, a mechanism for holding the outer peripheral portion of the substrate W is the same as that of the conventional cleaning apparatus shown in FIGS. 1 and 2.

The substrate holding mechanism 10 is different from the conventional substrate holding mechanism in that each of the base portions of the arms 11 has a trapezoidal cross-section having a flat upper surface 11f and inclined surfaces 11a, 11a inclined downwardly from both sides of the flat upper surface 11f as shown in FIG. 6, and each of the forward end portions of the arms 11 has a triangular cross-section having inclined surfaces 11a, 11a inclined downwardly from a center 11c of the arm 11 as shown in FIG. 7.

As described above, because the base portion of the arm 11 has a trapezoidal cross-section at an upper surface thereof and the forward end portion of the arm 11 has a triangular cross-section at an upper surface thereof, droplets attached to the upper surface of the arm 11 flow down the inclined surfaces 11a, 11a, and hence the amount of the droplets attached to or remaining on the upper surface of the arm 11 is greatly reduced. Particularly, since the substrate holding mechanism 10 is rotated during cleaning of the substrate W, the droplets attached to the upper surface of the base portion of the arm 11 are urged to flow toward the forward end portion of the arm 11 by a centrifugal force, and then flow down the triangular upper surface smoothly and rapidly. Thus, the droplets can hardly remain on the surface of the arm 11. Therefore, even if intense air streams are produced by high-speed rotation of the substrate holding mechanism 10 holding the substrate W after cleaning of the substrate W, there are no droplets which are carried by the air streams, and hence the front and reverse surfaces of the substrate W are prevented from being contaminated again.

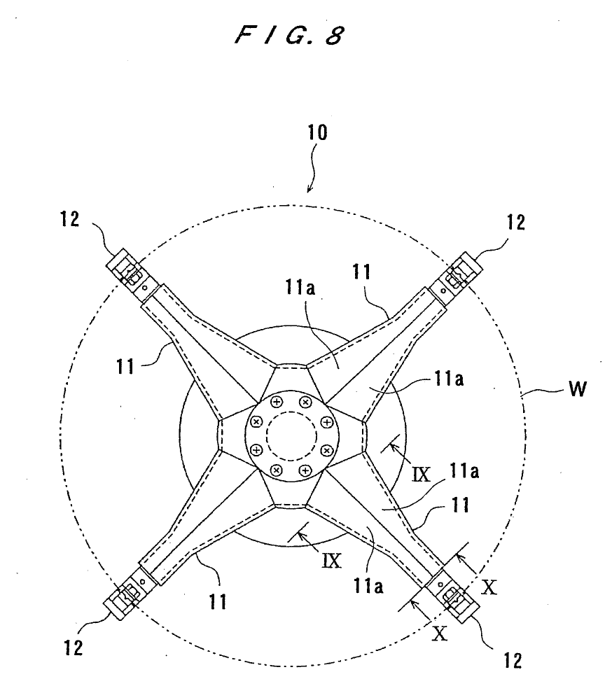

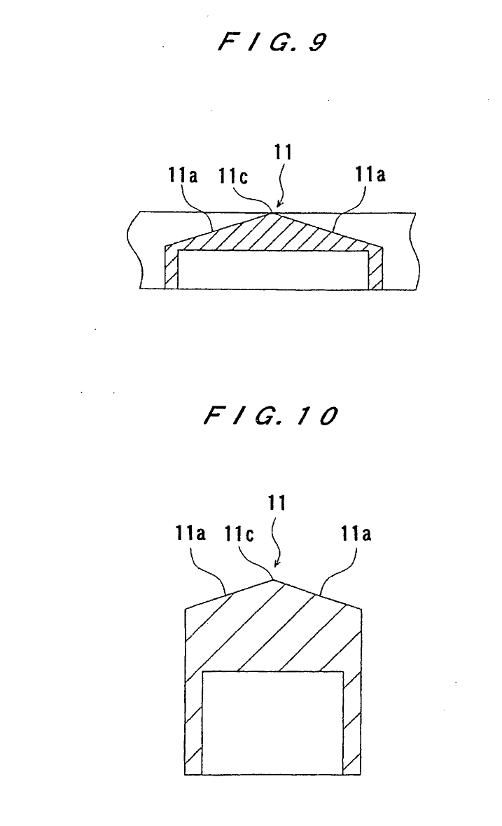

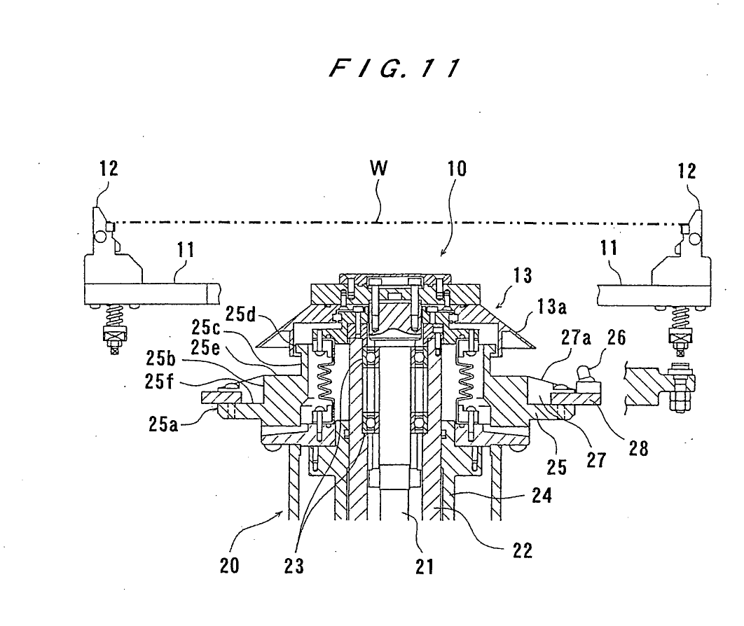

FIGS. 8 through 10 show a substrate cleaning apparatus according to a second embodiment of the present invention. FIG. 8 is a plan view of a substrate holding mechanism of a substrate cleaning apparatus, FIG. 9 is a cross-sectional view taken along line IX-IX of FIG. 8, and FIG. 10 is a cross-sectional view taken along line X-X of FIG. 8. The substrate holding mechanism 10 of the substrate cleaning apparatus according to the second embodiment is different from the substrate holding mechanism shown in FIGS. 5 through 7 in that the base portion and the forward end portion of the arm 11 have a triangular cross-section having inclined surfaces 11a, 11a inclined downwardly from a center 11c of the arm 11 as shown in FIGS. 9 and 10.

As described above, because the base portion and the forward end portion of the arm 11 have a triangular cross-section at their upper surfaces, droplets attached to the upper surface of the arm 11 flow down the inclined surfaces 11a, 11a smoothly and rapidly, and hence the amount of the droplets attached to or remaining on the upper surface of the arm 11 is greatly reduced.

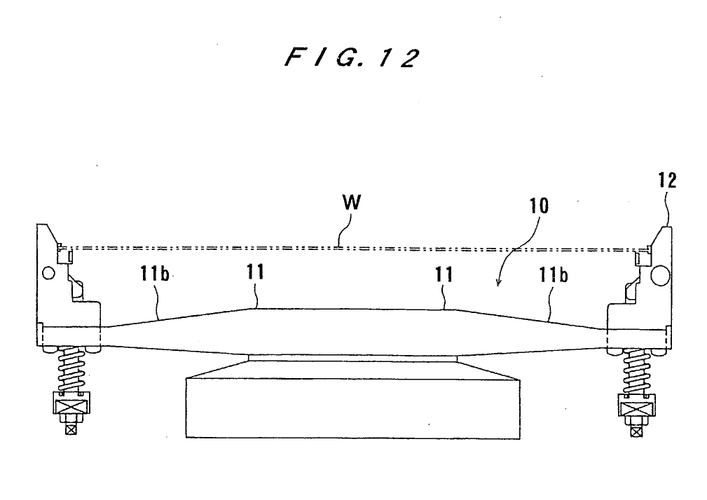

FIG. 11 is a cross-sectional view of a substrate holding mechanism and an upper part of the rotating mechanism of the substrate cleaning apparatus according to an embodiment of the present invention. In the substrate cleaning apparatus shown in FIG. 11, the cup-like member 13 attached to the lower surface of the central base portion of the four arms 11 has an inclined surface 13a inclined downwardly at an upper circumferential portion of the cup-like member 13. Specifically, the cup-like member 13 has a conical outer surface for forming the inclined surface 13a. Other components of the substrate cleaning apparatus shown in FIG. 11 are the same as those of the substrate cleaning apparatus shown in FIGS. 5 through 7 or FIGS. 8 through 10, and repetitive description is eliminated.

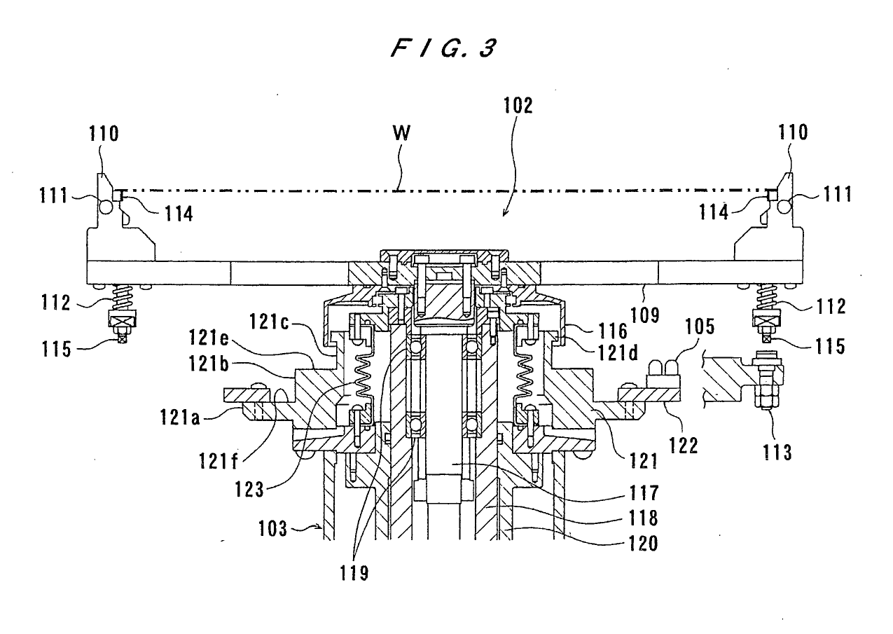

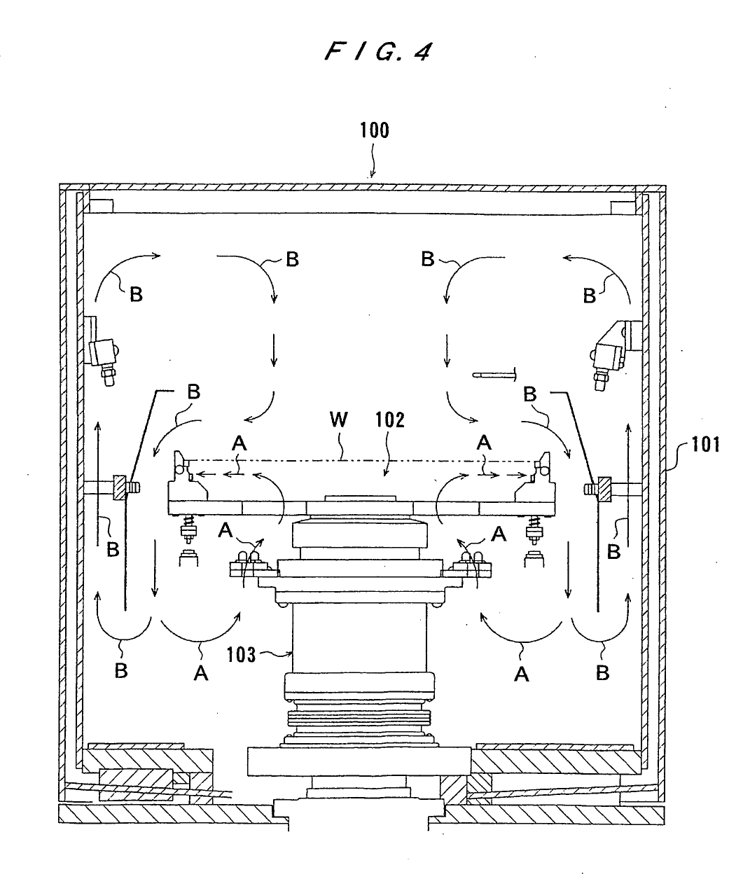

Further, the rotating mechanism 20 has substantially the same structure as the rotating mechanism 103 shown in FIG. 3. Specifically, the rotating mechanism 20 has a rotating shaft 21 whose upper end portion is located centrally in the cup-like member 13. The central base portion from which the four arms 11 are radially extended is fixed to the upper end of the rotating shaft 21. The rotating shaft 21 is disposed centrally in a support cylinder 22, and is rotatably supported through bearings 23 by the support cylinder 22. Further, a cylindrical member 24 is provided so as to enclose the support cylinder 22, and a step-like cylindrical flange member 25 is attached to the upper portion of the cylindrical member 24.

The flange member 25 has a larger-diameter portion 25a, an intermediate-diameter portion 25b, and a smaller-diameter portion 25c which are arranged in the order of diameter from the bottom. A projecting portion 25d is formed on the upper circumferential portion of the smaller-diameter portion 25c, and a flat surface 25e is formed on the upper part of the intermediate-diameter portion 25b, and a flat surface 25f is formed on the upper part of the larger-diameter portion 25a. Lower cleaning nozzles 26 for cleaning a lower surface of the substrate W are attached to the flat surface 25f of the larger-diameter portion 25a through a bracket 28.

The rotating mechanism 20 shown in FIG. 11 is different from the rotating mechanism 103 shown in FIG. 3 in that an inclined-surface forming member 27 is attached to the flange member 25 in order to form an inclined surface 27a which provides a continuous surface from the flat surface 25e of the intermediate-diameter portion 25b and is inclined downwardly from the outer edge of the flat surface 25e. Further, the inner periphery of the inclined-surface forming member 27 is located inside the outer periphery of the cup-like member 13. Therefore, liquid flowing down the inclined surface 13a of the cup-like member 13 flows onto the inclined surface 27a of the inclined-surface forming member 27, and then flows down the inclined surface 27a. In this embodiment, components of the substrate cleaning apparatus are formed such that the components have as few horizontal surfaces as possible. The cup-like member 13 constitutes a first member, and the inclined-surface forming member 27 constitutes a second member.

As described above, since the cup-like member 13 has the inclined surface 13a inclined downwardly at the outer upper circumferential portion of the cup-like member 13, and the inclined-surface forming member 27 having the inclined surface 27a inclined downwardly is attached to the flat surface 25f of the flange member 25, droplets attached to the upper surface (the inclined surface 13a) of the cup-like member 13 and the inclined surface 27a of the inclined-surface forming member 27 flow down the inclined surface 13a and the inclined surface 97a smoothly and promptly, and the amount of the droplets attached to or remaining on the rotating mechanism 20 is greatly reduced.

Next, comparison between the substrate cleaning apparatus according to the present invention and the conventional substrate cleaning apparatus was made using a substrate W having a diameter of 200 mm. The substrate cleaning apparatus according to the present invention included the above substrate holding mechanism 10 having the trapezoidal cross-section and the triangular cross-section at the upper surface of each of the arms 11, and the conventional substrate cleaning apparatus included the substrate holding mechanism having the flat surface at the upper surface of each of the arms. In this case, the substrate W was cleaned, and then spin-dried by the substrate cleaning apparatus according to the present invention and the conventional substrate cleaning apparatus. Then, the number of the particles having a diameter of 0.2 μm or larger which were attached to the surface of the substrate W was counted. As a result, about 30 particles were found on the surface of the substrate W which was cleaned and spin-dried by the substrate cleaning apparatus of the present invention, and several thousands to several tens of thousands of particles were found on the surface of the substrate W which was cleaned and spin-dried by the conventional substrate cleaning apparatus. Therefore, it was experimentally confirmed that recontamination of the substrate could be greatly reduced by the substrate cleaning apparatus of the present invention.

As described above, since components of the substrate holding mechanism 10 and the rotating mechanism 20 in the substrate cleaning apparatus to which a cleaning liquid tends to be attached have the inclined surfaces so that droplets attached to the surfaces of the components can flow down easily, droplets attached to or remaining on the surfaces of the components, particularly large droplets can flow down smoothly and rapidly. Thus, only minute droplets remain on the surfaces of the components in a small amount. The surface of the component is not limited to the inclined surface, and any surface of the component may be selected as long as such surface allows droplets to flow down easily. For example, a curved surface may be employed.

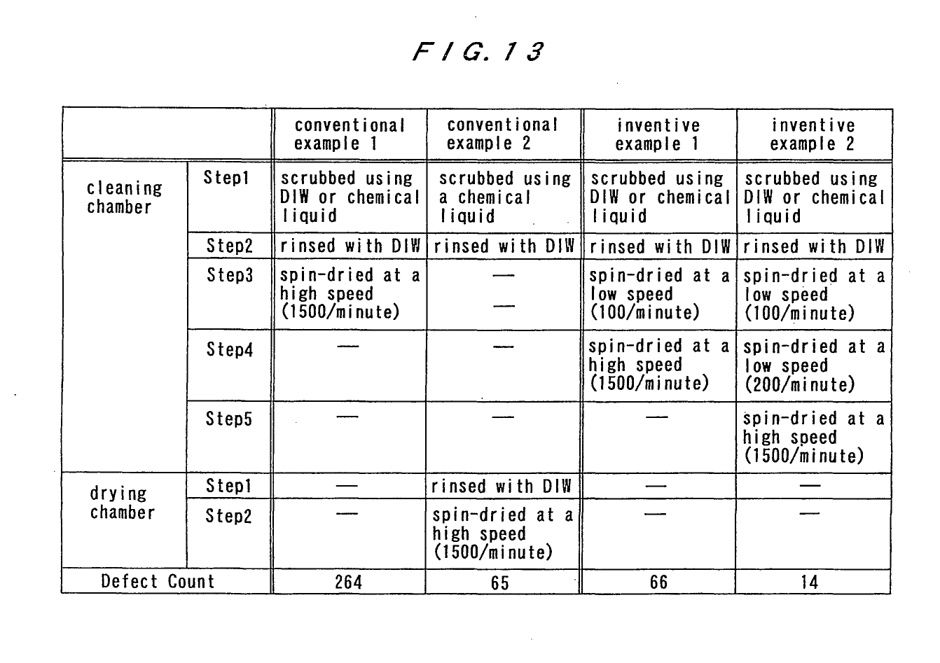

Further, in the above embodiments, each of the arms 11 has a trapezoidal cross-section or a triangular cross-section having inclined surfaces at an upper surface thereof. However, as shown in FIG. 12, the arm 11 may have an inclined surface 11b higher at the base portion of the arm 11 than at the forward end portion of the arm 11. Specifically, the inclined surface 11b is inclined downwardly toward radially outward direction. Further, components which allow droplets to flow down easily are not limited to those of the substrate holding mechanism 10 and the rotating mechanism 20. Specifically, other components in the substrate cleaning apparatus may have surfaces which allow droplets to flow down easily, thereby preventing the cleaned substrate W from being contaminated again.

Further, in the above embodiments, the surfaces of the components to which droplets are attached are configured so that the droplets can flow down the surfaces of the components easily. However, a surface of a portion where droplets tend to be attached or to remain may be made of a liquid repellent material such as TEFLON (trademark) or may be coated with a liquid repellent material, thereby reducing the amount of droplets attached to or remaining on the surface or preventing droplets from being attached to the surface. Furthermore, a surface configuration of a component may be designed such that droplets are hardly attached to a surface, and a surface of a portion where droplets tend to be attached or to remain may be made of a liquid repellent material such as TEFLON (trademark) or may be coated with a liquid repellent material, thereby further reducing the amount of droplets attached to the surface. Therefore, such structure is more preferable to prevent recontamination of the substrate W. The layout of various cleaning nozzles and the structure of the cleaning chamber in the substrate cleaning apparatus according to the present invention are substantially the same as those in the conventional substrate cleaning apparatus shown in FIG. 1.

In the above embodiments, the surfaces of the components where droplets are attached or remain are configured so that the droplets can be hardly attached to the surfaces of the components to prevent recontamination of the substrate W. However, a drying process for drying the substrate W by rotating the substrate W at a high speed after the surface of the substrate W is cleaned by supplying a cleaning liquid may be carried out in such a manner that the cleaned substrate W is prevented from being contaminated again. Specifically, in the drying process after the cleaning of the substrate, a rotational speed of the substrate is changed stepwise to prevent recontamination of the cleaned substrate W.

After the surface of the substrate W is cleaned by supplying a cleaning liquid, the substrate holding mechanism 10 for holding the substrate W is rotated at a low speed so that intense air streams which will carry droplets attached to or remaining on the components in the substrate cleaning apparatus are not produced. In this manner, the droplets attached to or remaining on the components of the apparatus are caused to flow down, thereby keeping away the droplets from the substrate W. That is, the droplets attached to or remaining on the components of the substrate holding mechanism and the rotating mechanism are sufficiently reduced. Thereafter, the substrate holding mechanism 10 holding the substrate W is rotated at a high speed to spin-dry the substrate W. A low rotational speed of the substrate holding mechanism 10 for removing the droplets therefrom may be varied stepwise in plural stages.

In the above method in which the rotational speed of the substrate is varied stepwise in the drying process after cleaning of the substrate, first, droplets attached to or remaining on the components of the apparatus, particularly the substrate holding mechanism and the rotating mechanism are caused to flow down after cleaning of the substrate, and thus the droplets are not carried by air streams in the high-speed spin-drying process and recontamination of the cleaned substrate can be prevented.

FIG. 13 shows a comparative example of a substrate cleaning method according to the present invention and a conventional substrate cleaning method in which a substrate is cleaned by deionized water (pure water) or a chemical liquid, rinsed with deionized water, and then spin-dried. In FIG. 13, in the conventional example 1, the substrate is scrubbed using deionized water (DIW) or a chemical liquid in step 1, and rinsed with deionized water in step 2, and spin-dried at a high speed of 1500 rpm in step 3. In the conventional example 2, the substrate is scrubbed using a chemical liquid in step 1, and rinsed with deionized water in step 2, and then the substrate is rinsed with deionized water in a drying chamber of a separate unit in another step 1, and spin-dried at a high-speed of 1500 rpm in another step 2.

On the other hand, according to the inventive example 1, the substrate is scrubbed using deionized water or a chemical liquid in step 1, rinsed with deionized water in step 2, spin-dried at a low rotational speed of 100 rpm in step 3, and then spin-dried at a high rotational speed of 1500 rpm in step 4. In the inventive example 2, the substrate is scrubbed using deionized water or a chemical liquid in step 1, rinsed with deionized water in step 2, spin-dried at a low rotational speed of 100 rpm in step 3, spin-dried at a low rotational speed of 200 rpm in step 4, and then spin-dried at a high rotational speed of 1500 rpm in step 5.

In the above cleaning method, the number of particles having a diameter of 0.2 μm or larger and attached to the substrate, i.e., Defect Count of particle contamination was 264 in the conventional example 1, 65 in the conventional example 2, 66 in the inventive example 1, and 14 in the inventive example 2. Thus, it was confirmed that the possibility of recontamination of the substrate could be greatly reduced in a case where the substrate is cleaned in the substrate cleaning method according to the present invention.

As described above, according to the present invention, the following excellent effects or advantages can be obtained:

1) Since parts of components in the apparatus to which a cleaning liquid tends to be attached have a surface configuration to which droplets are hard to be attached, the droplets containing a polishing liquid such as slurry, ground-off material removed from the substrate by polishing, and contaminants such as by-products of chemical cleaning are hardly attached to such parts. Therefore, the droplets are not carried by air streams in the drying process, and the substrate can be cleaned without being contaminated again. Further, the substrate can be cleaned and dried within the same unit which is not separated into a cleaning chamber and a drying chamber without recontamination of the substrate.

2) Since surfaces of parts to which a cleaning liquid tends to be attached comprise inclined surfaces or curved surfaces, droplets attached to such parts flow down promptly. Therefore, the droplets are not carried by air streams in the drying process, and the substrate can be cleaned without being contaminated again. Further, the substrate can be cleaned and dried within the same unit which is not separated into a cleaning chamber and a drying chamber without recontamination of the substrate.

3) Since surfaces of parts to which a cleaning liquid tends to be attached are composed of a liquid repellent material or are coated with a liquid repellent material, droplets are hardly attached to such parts. Therefore, the droplets are not carried by air streams in the drying process, and the substrate can be cleaned without being contaminated again. Further, the substrate can be cleaned and dried within the same unit which is not separated into a cleaning chamber and a drying chamber without recontamination of the substrate.

4) The rotational speed of the substrate is varied stepwise in the spin-drying process after cleaning of the substrate. For example, the substrate is rotated first at a low speed so that intense air streams are not produced, thereby removing the droplets from the substrate holding mechanism and the like, and then the substrate is rotated at a high speed to dry the substrate. Thus, even if the intense air streams are produced due to the high-speed rotation, because the droplets have been removed from the substrate holding mechanism and the like, there exist no droplets which are carried by the air streams, and the cleaned substrate can be prevented from being contaminated again. Further, the substrate can be cleaned and dried within the same unit which is not separated into a cleaning chamber and a drying chamber without recontamination of the substrate.

5) The rotational speed of the substrate is changed stepwise from a low-rotational speed removing step for removing droplets to a high-rotational speed drying step for spin-drying the substrate. When the substrate is rotated at a high speed in the drying step, even if intense air streams are produced, because the droplets have been removed from the substrate holding mechanism and the like, there exist no droplets which are carried by the air streams, and the cleaned substrate can be prevented from being contaminated again. Further, the substrate can be cleaned and dried within the same unit which is not separated into a cleaning chamber and a drying chamber without recontamination of the substrate.

### INDUSTRIAL APPLICABILITY

The present invention is applicable to a substrate cleaning apparatus and method for cleaning a substrate such as a semiconductor wafer used in a semiconductor fabricating process or the like.

1-12. (canceled)

13. A substrate cleaning apparatus for cleaning a substrate by supplying a cleaning liquid and then drying a cleaned substrate, comprising:
a substrate holding mechanism configured to hold the substrate; and
a rotating mechanism configured to rotate said substrate holding mechanism;
wherein said substrate holding mechanism has at least three arms having an inclined surface, and said inclined surface of each of said at least three arms is inclined downwardly toward radially outward direction and comprises a liquid repellent material or a coating of a liquid repellent material; and
wherein said rotating mechanism has a first member comprising a cup-like member, and said cup-like member comprises a liquid repellent material or a coating of a liquid repellent material.

14. A substrate cleaning apparatus according to claim 13, wherein said rotating mechanism has said first member and a second member, and said first member is located above said second member and an outer periphery of said first member is located radially outwardly of an inner periphery of said second member.

15. A substrate cleaning apparatus according to claim 13, wherein said substrate holding mechanism holds an outer peripheral portion of the substrate.

16. A substrate cleaning apparatus according to claim 13, wherein said rotating mechanism rotates said substrate holding mechanism at a variable rotational speed.

17. A substrate cleaning method for cleaning a substrate by supplying a cleaning liquid and then drying a cleaned substrate, comprising:
holding the substrate by a substrate holding mechanism; and
rotating the substrate held by said substrate holding mechanism by a rotating mechanism to remove droplets from the substrate and dry the substrate;
wherein said substrate holding mechanism has at least three arms having an inclined surface, and said inclined surface of each of said at least three arms is inclined downwardly toward radially outward direction and comprises a liquid repellent material or a coating of a liquid repellent material;
wherein said rotating mechanism has a cup-like member, and said cup-like member comprises a liquid repellent material or a coating of a liquid repellent material; and
wherein a rotational speed of the substrate is changed stepwise by said rotating mechanism.

18. A substrate cleaning method according to claim 17, wherein said rotational speed of the substrate comprises a low rotational speed of the substrate for removing droplets from components of said substrate holding mechanism and a high rotational speed of the substrate for spin-drying the substrate.
